(19) United States
(12) Patent Application Publication
(10) Pub. No.: US 2018/0038735 A1
(43) Pub. Date: Feb. 8, 2018

(54) METHOD OF DETECTING TEMPERATURE CHANGE WITH INFRARED AND METHOD OF DETECTING MOVING VEHICLE WITH INFRARED

(71) Applicant: NATIONAL CHUNG SHAN INSTITUTE OF SCIENCE AND TECHNOLOGY, TAOYUAN CITY (TW)

(72) Inventors: SHIH-CHE CHIEN, HSINCHU CITY (TW); FENG-CHIA CHANG, KAOHSIUNG CITY (TW)

(21) Appl. No.: 15/228,612

(22) Filed: Aug. 4, 2016

(51) Int. Cl. G01J 5/00

(52) U.S. Cl. CPC G01J 5/0022

(57) ABSTRACT

A method of detecting temperature changes with infrared includes the steps of providing a plurality of infrared detection devices for detecting temperature changes in a region; turning on the plurality of infrared detection devices one by one at a first time interval; capturing temperature signals of the plurality of infrared detection devices one by one at a second time interval; and comparing the temperature signals with a background temperature signal to calculate temperature differences and thereby detect temperature changes in the region. A method of detecting moving vehicles with infrared is further introduced.

### FIELD OF THE INVENTION

The present invention relates to methods of detecting temperature changes and, more particularly, to a method of detecting temperature changes with infrared and a method of detecting moving vehicles with infrared.

### BACKGROUND OF THE INVENTION

In general, by detecting the temperature changes over a specific area, it is feasible to detect whether a human being or animal has entered the area with a view to carrying out burglary detection, discern the direction which an object is moving by performing motion logical analysis on the changes in the temperature of each sensing block, and detect the movement of vehicles with a view to carrying out traffic surveillance and red-light running detection.

A conventional method of detecting the temperature changes over a specific area usually requires an infrared temperature sensor. Infrared temperature sensors work by optoelectronic technology to detect a specific infrared wavelength band signal sent from an object because of thermal radiation, convert the signal into an image graphic discernible by the human eye, and calculate the temperature value. The aforesaid technology enables human beings to circumvent visual barriers and observe the distribution of temperature on the surfaces of an object. If an object surface temperature extends beyond the absolute zero degree (OK), it will emit electromagnetic waves whose strength and wavelength vary with temperature. Depending on detection principles, conventional infrared sensors fall into two categories: thermal detectors and photon detectors. The thermal detectors convert incident infrared into heat energy and thus change in temperature; the temperature change is accompanied by changes in the physical properties of materials, and in consequence the material changes are detected. The photon detectors absorb the energy of infrared photons and thus trigger an electron transition in a crystal between energy levels, thereby generating voltage or current signals for measurement.

A conventional method of detecting the changes in temperature over a specific area requires a single infrared sensor. Despite their low costs, infrared sensors take at least 125 ms to sense environmental information; as a result, their sampling frequency is overly low to the detriment of system detection speed as well as detection of high-frequency temperature changes. Unfortunately, any attempt to increase the sampling speed of infrared sensors is likely to end up in collecting inaccurate information and thus compromising system stability.

Accordingly, it is imperative for the technical field of infrared temperature detection to increase the sampling frequency of temperature detection carried out by an infrared sensor sensing device to thereby efficiently detect high-frequency temperature changes.

### SUMMARY OF THE INVENTION

In view of the aforesaid drawbacks of the prior art, it is an objective of the present invention to integrate a plurality of infrared sensor sensing devices, increase the temperature detection sampling frequency of the infrared sensor sensing devices, and efficiently detect high-frequency temperature changes so as to detect moving vehicles.

In order to achieve the above and other objectives, the present invention provides a method of detecting temperature changes with infrared, comprising the steps of:

providing a plurality of infrared detection devices for detecting temperature changes in a region;

turning on the plurality of infrared detection devices one by one at a first time interval;

capturing temperature signals of the plurality of infrared detection devices one by one at a second time interval; and

comparing the temperature signals with a background temperature signal to calculate temperature differences and thereby detect temperature changes in the region.

Regarding the method, the infrared detection devices are infrared temperature sensors.

Regarding the method, the plurality of infrared detection devices are in the number of four.

Regarding the method, the first time interval is 62.5 ms.

Regarding the method, the second time interval is 62.5 ms.

Regarding the method, the background temperature signal is generated by calculating a weighted average with the newly-captured temperature signals of the infrared detection devices.

Regarding the method, a temperature difference threshold is configured for use in detecting temperature changes in the region, and it will be justified to determine that a temperature change occurs to the region, if the difference between a temperature indicated by an aforesaid temperature signal and a temperature indicated by the background temperature signal is larger than the temperature difference threshold.

Regarding the method, the region is divided into a plurality of sub-regions whose temperature changes are detected.

Regarding the method, the plurality of sub-regions are arranged in a 4×4 matrix and thus provided in the number of 16.

The method further comprises the step of converting a result of the comparison between the temperature signals of the plurality of infrared detection devices and the background temperature signal into a voltage signal, allowing a first volt value to denote presence of a temperature difference and a second volt value to denote absence of a temperature difference, and performing computation on all the comparison results with a logic integration circuit by an OR logical operator, so as for a result of the computation to indicate whether the region undergoes a temperature change.

Regarding the method, the first volt value is 5V, and the second volt value is 0V.

In order to achieve the above and other objectives, the present invention provides a method of detecting moving vehicles with infrared, comprising the steps of:

detecting temperature changes in a plurality of sub-regions at the first point in time with the method;

dividing the plurality of sub-regions into a plurality of rows according to a predetermined vehicle advancing direction;

detecting temperature changes in the plurality of sub-regions at the second point in time with the method; and

comparing the detection results of the first point in time and the second point in time, and determining that the vehicle is moving in one of the plurality of rows upon detection of temperature changes in the row at both the first point in time and the second point in time and upon detection that the sub-regions which undergo temperature changes at the second point in time in the row are different from the sub-regions which undergo temperature changes at the first point in time in the row.

Regarding the method, the sub-regions are arranged in a 4×4 matrix and thus provided in number of 16 in step (A) and step (C), and the sub-regions are arranged in four rows in step (B) and step (D).

Regarding the method, the plurality of sub-regions each allow for a 1 m×1 m detection area.

Regarding the method, the sub-regions are divided into an upper group and a lower group according to a line located at a crossroads and intended for vehicles to stop at, so as to determine whether the moving vehicle has gone beyond the stopping line at the crossroads according to whether the sub-regions which undergo the detected temperature changes belong to the upper group or the lower group.

Advantages of the methods of the present invention are described below. By integrating a plurality of infrared sensors and effectuating parallel processing, it is feasible to separate the points in time of sensor sampling, increase the number of instances of sampling per unit time, and increase a detection system's sampling frequency. Given a logic integration circuit, the methods integrate the output information of the sensors and thus efficiently increase the response time to the detection of temperature changes. The methods can be applied to a red-light running detection system which operates at a crossroads to efficiently enhance the accuracy of the red-light running detection system and cut system construction costs.

Both the above summary and the following description aim to explain the techniques and means required to achieve the predetermined objectives of the present invention as well as the effectives thereof. The other objectives and advantages of the present invention are described below.

### BRIEF DESCRIPTION OF THE DRAWINGS

Objectives, features, and advantages of the present invention are hereunder illustrated with specific embodiments in conjunction with the accompanying drawings, in which:

FIG. 1 is a flowchart of a method of detecting temperature changes with infrared according to embodiment 1 of the present invention;

FIG. 2 is a schematic view of temperature signal capturing frequency of a plurality of infrared detection devices according to embodiment 1 of the present invention;

FIG. 3 is a schematic view of detecting temperature changes in a region according to embodiment 1 of the present invention;

FIG. 4 is a flowchart of a method of detecting temperature differences with infrared according to embodiment 2 of the present invention;

FIG. 5a and FIG. 5b are pictures taken of vehicles moving on a road with infrared;

FIG. 6 is a flowchart of a method of detecting moving vehicles with infrared according to embodiment 3 of the present invention; and

FIG. 7 and FIG. 8 are schematic views of the method of detecting moving vehicles with infrared according to embodiment 3 of the present invention.

### DETAILED DESCRIPTION OF THE PREFERRED EMBODIMENTS

### Embodiment 1

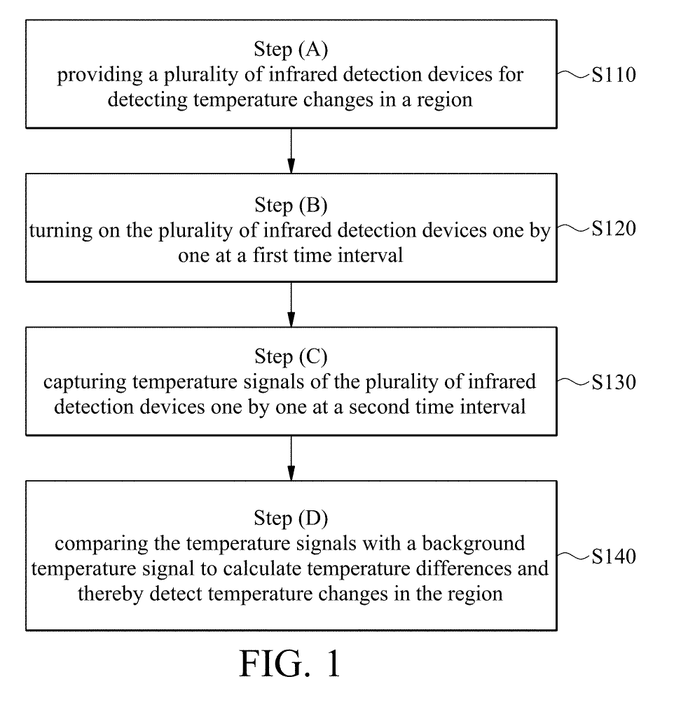

FIG. 1 is a flowchart of a method of detecting temperature changes with infrared according to embodiment 1 of the present invention. As shown in FIG. 1, in embodiment 1, the method of detecting temperature changes with infrared comprises four steps, namely step (A) through step (D).

Step (A) involves providing a plurality of infrared detection devices for detecting temperature changes in a region (S110), wherein the infrared detection devices are infrared temperature sensors provided in the form of thermal detectors or photon detectors. In this embodiment, the infrared detection devices are in the number of four, but the present invention is not limited thereto.

Step (B) involves turning on the plurality of infrared detection devices one by one at a first time interval (S120), wherein the first time interval is subject to changes according to the performance and quantity of the infrared detection devices, and is 62.5 ms in this embodiment.

Step (C) involves capturing temperature signals of the plurality of infrared detection devices one by one at a second time interval (S130), wherein the second time interval equals the first time interval, that is, 62.5 ms. In this embodiment, the way of capturing the temperature signals of the plurality of infrared detection devices entails capturing the temperature signal of the first infrared detection device, waiting for 62.5 ms, capturing the temperature signal of the second infrared detection device, waiting for 62.5 ms, capturing the temperature signal of the third infrared detection device, waiting for 62.5 ms, capturing the temperature signal of the fourth infrared detection device, waiting for 62.5 ms, capturing the temperature signal of the first infrared detection device, waiting for 62.5 ms, and so on. The temperature signals are captured one by one at the second time interval in the region; alternatively, the region is divided into sub-regions so that the sub-regions have their respective temperature signals captured. In this embodiment, the sub-regions are in the number of 16.

Step (D) involves comparing the temperature signals with a background temperature signal to calculate temperature differences and thereby detect temperature changes in the region (S140). The background temperature signal is generated by calculating a weighted average with the newly-captured temperature signals of the infrared detection devices. In this embodiment, 30 temperature signals are newly captured, whereas the temperature differences are calculated according to a temperature difference threshold adjustable in accordance with the environment of the region. In this embodiment, the temperature difference threshold is 3° C. It will be confirmed that a temperature change occurs to the region, if the difference between the temperature indicated by an aforesaid temperature signal and the temperature indicated by the background temperature signal is larger than the temperature difference threshold.

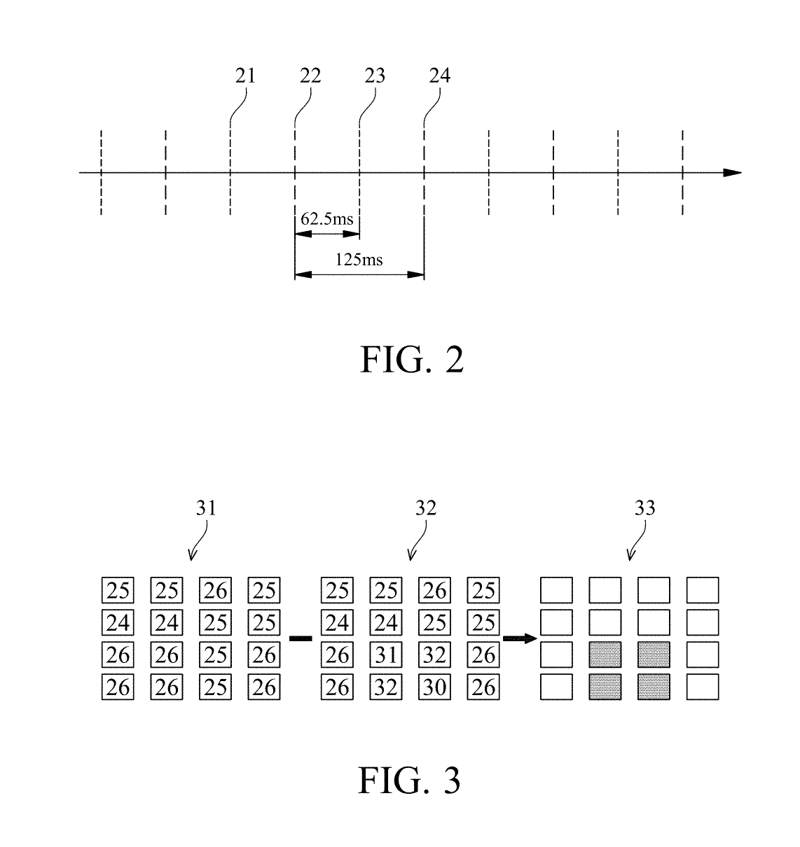

FIG. 2 is a schematic view of temperature signal capturing frequency of a plurality of infrared detection devices according to embodiment 1 of the present invention. As shown in FIG. 2, in this embodiment, the four infrared detection devices are turned on one by one at a time interval of 62.5 ms, allowing a temperature signal 21 of the first infrared detection device to be captured 62.5 ms earlier than a temperature signal 22 of the second infrared detection device, the temperature signal 22 of the second infrared detection device to be captured 62.5 ms earlier than a temperature signal 23 of the third infrared detection device, and the temperature signal 23 of the third infrared detection device to be captured 62.5 ms earlier than a temperature signal 24 of the fourth infrared detection device. Since the temperature signals of the four infrared detection devices are captured one by one, the temperature signals 21, 22, 23, 24 are each captured every 250 ms, and temperature signal sampling occurs every 62.5 ms advantageously.

FIG. 3 is a schematic view of detecting temperature changes in a region according to embodiment 1 of the present invention. As shown in FIG. 3, each block denotes a sub-region and bears a number indicative of the temperature detected, wherein sub-regions with temperature changes are indicated by gray blocks as opposed to white blocks. Referring to FIG. 3, in this embodiment, if the difference between the temperature indicated by each of temperature signals 32 captured at the second time interval and attributed to a plurality of infrared detection devices from 16 (i.e., 4×4) sub-regions and the temperature indicated by each of background temperature signals 31 from the corresponding sub-regions is larger than the temperature difference threshold, it can be confirmed that temperature changes occur to the sub-regions, thereby obtaining a detection result 33 of temperature changes.

### Embodiment 2

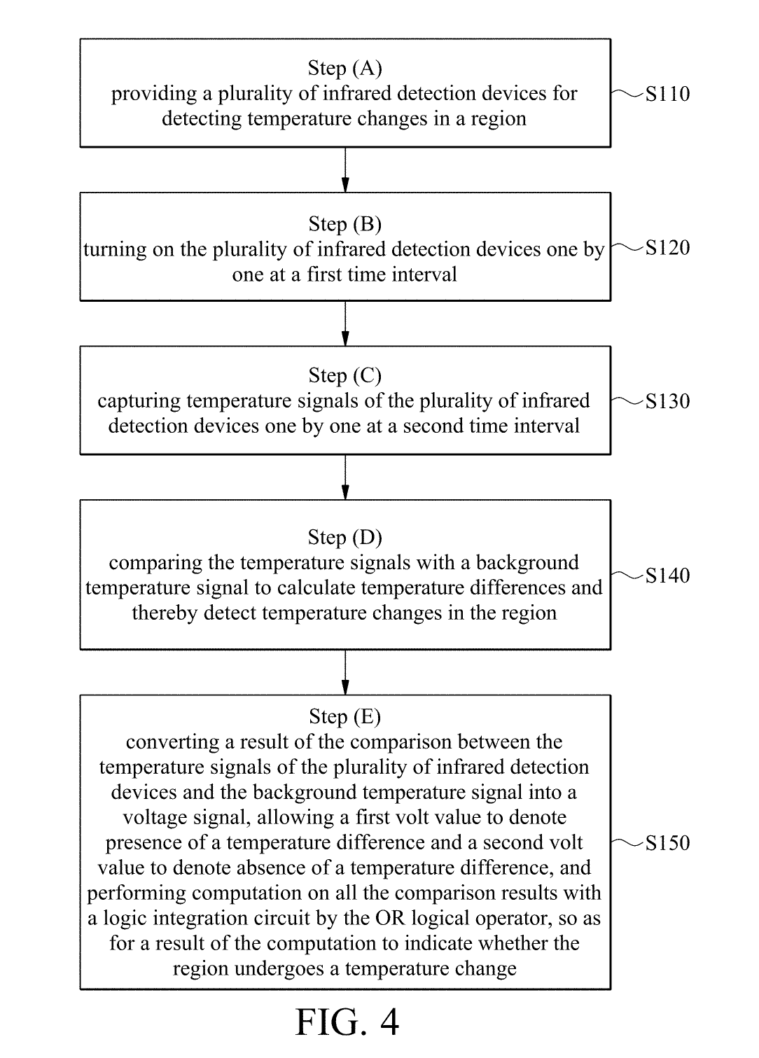

FIG. 4 is a flowchart of a method of detecting temperature differences with infrared according to embodiment 2 of the present invention. Unlike embodiment 1, embodiment 2 includes step (E) S150 which involves converting a result of the comparison between the temperature signals of the plurality of infrared detection devices and the background temperature signal into a voltage signal, allowing a first volt value to denote the presence of a temperature difference and a second volt value to denote the absence of a temperature difference, and performing computation on all the comparison results with a logic integration circuit by the OR logical operator, so as for a result of the computation to indicate whether the region undergoes a temperature change. In this embodiment, the first volt value is 5V, and the second volt value is 0V.

### Embodiment 3

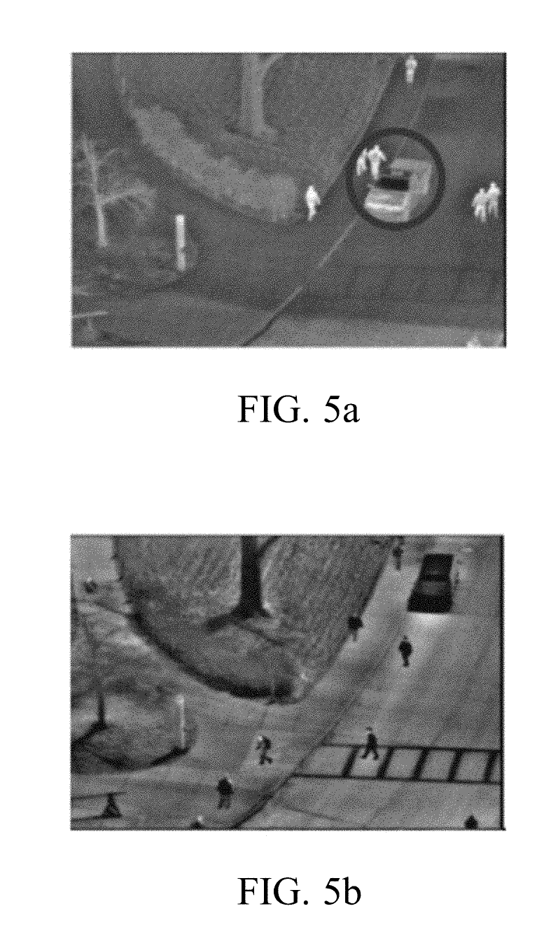

In embodiment 3, the method of detecting moving vehicles with infrared is performed according to the difference in temperature between a road and a vehicle thereon. FIG. 5a and FIG. 5b are pictures taken of vehicles moving on a road with infrared. In the pictures of FIG. 5a and FIG. 5b, brightness increases with temperature. Referring to FIG. 5a, the picture, taken on a cloudy day, shows that the vehicle (encircled), especially its engine cooler, has a higher temperature than the road. Referring to FIG. 5b, the picture, taken on a sunny day, shows that the vehicle has a lower temperature than the road.

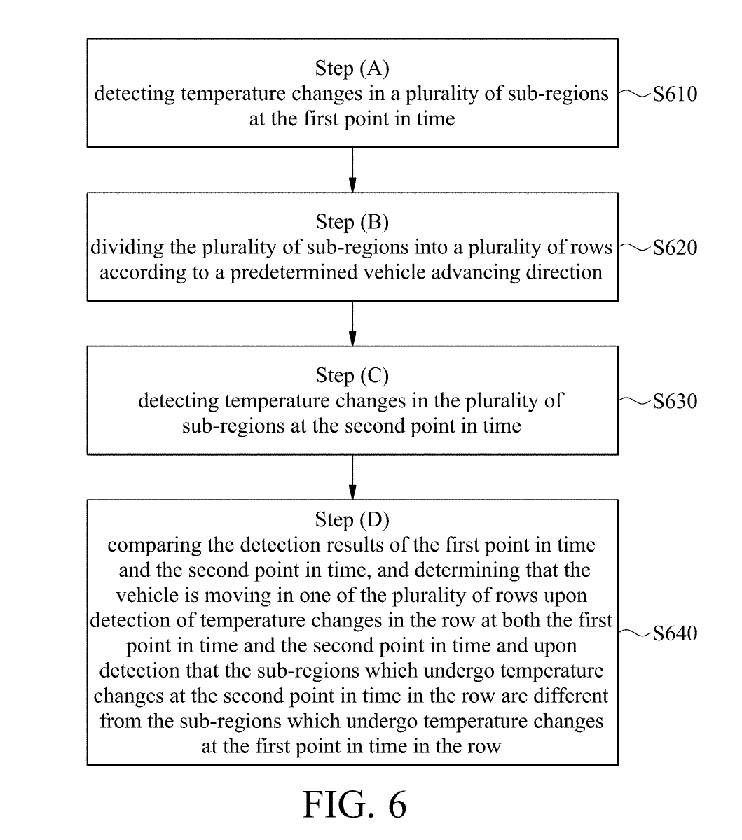

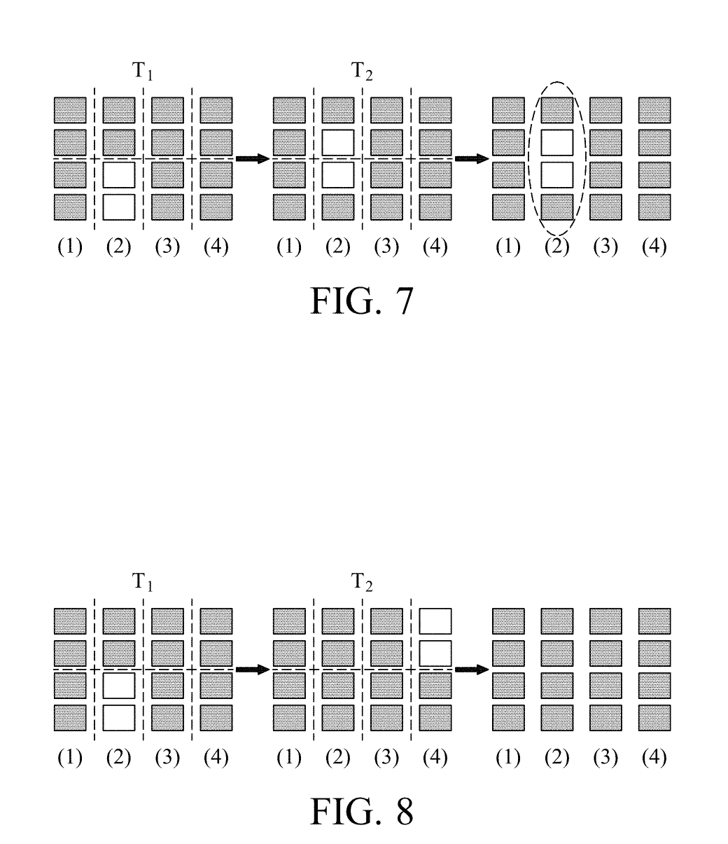

FIG. 6 is a flowchart of a method of detecting moving vehicles with infrared according to embodiment 3 of the present invention. As shown in FIG. 6, in embodiment 3, the method of detecting moving vehicles with infrared comprises four steps, namely step (A) through step (D). FIG. 7 and FIG. 8 are schematic views of the method of detecting moving vehicles with infrared according to embodiment 3 of the present invention. As shown in FIG. 7 and FIG. 8, each sub-region is denoted by a block, and the blocks bear deep color to indicate the sub-regions with no temperature change detected and bear pale color to indicate the sub-regions with a temperature change detected. Referring to FIG. 7 and FIG. 8, the diagrams show the result of detecting temperature changes at the first point in time T1 (left), the result of detecting temperature changes at the second point in time T2 (middle), and the result of detecting a moving vehicle (right).

Referring to FIG. 6, step (A) involves detecting temperature changes in a plurality of sub-regions at the first point in time with the method of embodiment 1 (S610). Referring to FIG. 7 and FIG. 8, in this embodiment, the 16 sub-regions are arranged in a 4×4 matrix and also known as a region of interest (ROI).

Referring to FIG. 6, step (B) involves dividing the plurality of sub-regions into a plurality of rows according to a predetermined vehicle advancing direction (S620). Referring to FIG. 7 and FIG. 8, the predetermined vehicle advancing direction runs upward, and thus the 16 sub-regions are divided into four rows separated by vertical dashed lines, namely a first row (1), a second row (2), a third row (3), and a fourth row (4). Referring to FIG. 7 and FIG. 8, at the first point in time T1, temperature changes are detected in the two underlying sub-regions (pale-colored blocks) of the second row (2).

Referring to FIG. 6, step (C) involves detecting temperature changes in the plurality of sub-regions at the second point in time with the method of embodiment 1 (S630). Referring to FIG. 7, at the second point in time T2, temperature changes are detected in the two intermediate sub-regions (pale-colored blocks) of the second row (2). Referring to FIG. 8, at the second point in time T2, temperature changes are detected in the two uppermost sub-regions (pale-colored blocks) of the fourth row (4).

Referring to FIG. 6, step (D) involves comparing the detection results of the first point in time and the second point in time, and determining that the vehicle is moving in one of the plurality of rows upon detection of temperature changes in the row at both the first point in time and the second point in time and upon detection that the sub-regions which undergo temperature changes at the second point in time in the row are different from the sub-regions which undergo temperature changes at the first point in time in the row (S640). Referring to FIG. 7, it is justified to determine that the vehicle is moving in the second row (2) upon detection of temperature changes in the second row (2) at both the first point in time T1 and the second point in time T2 and upon detection that the sub-regions which undergo temperature changes at the second point in time T2 in the second row (2) are different from the sub-regions which undergo temperature changes at the first point in time T1 in the second row (2). Referring to FIG. 8, it is justified to determine that the vehicle is not moving in the second row (2), because temperature changes are detected in the second row (2) at the first point in time T1 instead of the second point in time T2. Referring to FIG. 7 and FIG. 8, the horizontal dashed lines denote the line located at a crossroads and intended for vehicles to stop at and divide the sub-regions into an upper group and a lower group so that it is feasible to determine whether the moving vehicle has gone beyond the stopping line at the crossroads according to whether the sub-regions which undergo the detected temperature changes belong to the upper group or the lower group. Referring to FIG. 7, at the second point in time T2, the sub-regions which undergo the detected temperature changes belong to the upper group, and thus it is justified to determine that the moving vehicle in the second row (2) has gone beyond the stopping line at the crossroad, start a picture-taking device, take pictures of the vehicle with the picture-taking device, and take a legal action against the vehicle's driver for red-light running.

Temperature changes are detected with the methods of embodiments 1, 3 to increase the temperature signal sampling frequency in the region to one instance of sampling every 62.5 ms, so as to not only speed up temperature detection but also efficiently detect vehicles moving at high speed, say 50 km/h or higher.

In step (D) of the method of embodiment 3, vehicles which are idle or not moving in the predetermined vehicle advancing direction are excluded from the detection process, thereby minimizing erroneous judgment.

In embodiment 3, the sub-regions each allow for a 1 m×1 m detection area whereby pets and pedestrians are excluded from the detection process, thereby minimizing erroneous judgment.

### Embodiment 4

In embodiment 4, a red-light running detection system executes the method of embodiment 3 for detecting moving vehicles with infrared. The red-light running detection system comprises a plurality of infrared detection devices, a plurality of infrared temperature sensors, and a microprocessor electrically connected to the plurality of infrared temperature sensors. The microprocessor turns on the plurality of infrared detection devices one by one at a first time interval, captures temperature signals of the plurality of infrared detection devices one by one at a second time interval, and compares the temperature signals with a background temperature signal to calculate temperature differences and thereby detect temperature changes in the region, thereby effectuating the method of detecting temperature changes with infrared according to embodiment 1. In this embodiment, the infrared detection devices are infrared temperature sensors. The microprocessor divides the region into 16 sub-regions arranged in a 4×4 matrix to thereby detect temperature changes in the sub-regions. In this embodiment, the microprocessor detects whether the sub-regions undergo temperature changes at the first point in time, divides the sub-regions into four rows according to a predetermined vehicle advancing direction, detects whether the sub-regions undergo temperature changes at the second point in time, compares the detection results of the first point in time and the second point in time, and determining that the vehicle is moving in one of the plurality of rows upon detection of temperature changes in the row at both the first point in time and the second point in time and upon detection that the sub-regions which undergo temperature changes at the second point in time in the row are different from the sub-regions which undergo temperature changes at the first point in time in the row. In doing so, the microprocessor executes the method of detecting moving vehicles with infrared according to embodiment 3 of the present invention. In this embodiment, the sub-regions are divided into four rows corresponding to lanes on a road, respectively, so as to identify the lane in which a vehicle is moving. In this embodiment, the microprocessor divides the sub-regions into an upper group and a lower group according to a line located at a crossroads and intended for vehicles to stop at and determines whether a moving vehicle has gone beyond the stopping line according to whether the sub-regions with detected temperature changes belong to the upper group or lower group. The aforesaid way of grouping the sub-regions is identical to that illustrated by embodiment 3 and shown in FIG. 7 and FIG. 8.

In embodiment 4, the red-light running detection system is electrically connected to traffic lights. When the red light is on, the traffic lights send a signal through the red-light running detection system to start the red-light running detection system. When the green light is on, the traffic lights send another signal through the red-light running detection system to shut down the red-light running detection system. In embodiment 4, the red-light running detection system is electrically connected to a picture-taking device to send a signal to the picture-taking device and thus cause the picture-taking device to take pictures of a vehicle upon detection that the vehicle has moved beyond the stopping line.

The red-light running detection system is mounted in place to either face downward or face laterally. To face downward and detect vehicles below, the red-light running detection system is mounted on an extension rod of the traffic lights. The downward-facing red-light running detection system has advantages of being rarely confronted with hidden detection regions and discerning accurately the lanes in which vehicles are moving as well as the disadvantages of being difficult to mount and being compromised by a long distance between the system and the vehicle to be detected. To face and detect vehicles laterally, the red-light running detection system is mounted on a traffic light post or lamppost. The laterally-facing red-light running detection system has the advantage of detecting slow-moving vehicles accurately because of a short distance between the system and the vehicle to be detected as well as a closeup taken at the vehicle with every infrared detection device and the disadvantage of being often confronted with hidden detection regions, for example, failing to detect the farther one of two vehicles moving in two different lanes, respectively, and passing a detection region of the red-light running detection system simultaneously.

Test 1

In test 1, a red-light running detection system with a plurality of infrared detection devices according to embodiment 4 and a red-light running detection system with only one infrared detection device are mounted in place on the same road. The red-light running detection systems are electrically connected to traffic lights and a picture-taking device in the same manner as the method of embodiment 4, so as to take pictures of law-violating vehicles and collect the following test data:

detection rate, which is calculated with reference to the total number of vehicles passing the stopping line;

lane judgment accuracy rate, which evaluates the accuracy in the judgment of the lanes in which vehicles are moving; and

picture-taking position correction rate, which is intended to determine whether the system's delay falls within an allowable range, and the picture-taking position of a vehicle is deemed correct whenever a picture taken of the vehicle shows that the rear end of the vehicle was behind the stopping line.

The result of the test conducted on the red-light running detection system with only one infrared detection device is shown in Table 1 below.

TABLE 1

| red-light running | detection | lane judgment | picture-taking position |
|---|---|---|---|
| detection system | rate | accuracy rate | correction rate |
| laterally-facing to | 90.7 | N | 82.3 |
| detect cars | | | |
| laterally-facing to | 68.1 | N | 43.6 |
| detect motorbikes | | | |

The red-light running detection system with only one infrared detection device is not capable of identifying the lanes in which vehicles are moving and thus does not provide any data pertaining to the lane judgment accuracy rate.

The result of the test conducted on the red-light running detection system with a plurality of infrared detection devices according to embodiment 4 is shown in Table 2 below.

TABLE 2

| | detection | lane judgment | picture-taking position |
|---|---|---|---|
| | rate | accuracy rate | correction rate |
| laterally-facing to | 94.2 | 75.6 | 90.3 |
| detect cars | | | |
| laterally-facing to | 79.4 | 100 | 67.5 |
| detect motorbikes | | | |
| downward-facing to | 95.3 | 93 | 93 |
| detect cars | | | |

Referring to Table 2, according to the present invention, the red-light running detection system achieves a car detection rate of 95.3% and a motorbike detection rate of 79.4%. The laterally-facing red-light running detection system has an advantage of detecting motorbikes easily, whereas the downward-facing red-light running detection system has an advantage of satisfactory lane judgment accuracy rate. According to the present invention, the red-light running detection system with a plurality of infrared detection device is effective in enhancing the detection rate and the picture-taking position correction rate as well as precluding the effect of changes in shadows on the detection system.

A vehicle which pictures are taken of upon its entry into a detection region is likely to be wrongly detected with a red-light running detection system which lacks a logical judgment function. In view of this, conventional detection systems, such as radars and induction coils, are always provided in the number of two or more to not only perform logical judgment but also ensure a high detection rate by cross-checking the results of detection conducted with the two or more detection systems, albeit incurring high costs. By contrast, the red-light running detection system of the present invention is capable of performing logical judgment and detection and thereby able to operate independently in providing a reliable accuracy rate and cut system installation costs.

Therefore, methods of detecting temperature changes with infrared and detecting moving vehicles with infrared according to the present invention are applicable to a red-light running detection system at a crossroads to efficiently enhance the accuracy rate of the red-light running detection system and cut system installation costs.

Although the present invention is disclosed above by embodiments, the embodiments are not restrictive of the present invention. Any persons skilled in the art can make some changes and modifications to the embodiments without departing from the spirit and scope of the present invention. Accordingly, the legal protection for the present invention should be defined by the appended claims.

What is claimed is:

1. A method of detecting temperature changes with infrared, comprising the steps of:
(A) providing a plurality of infrared detection devices for detecting temperature changes in a region;
(B) turning on the plurality of infrared detection devices one by one at a first time interval;
(C) capturing temperature signals of the plurality of infrared detection devices one by one at a second time interval; and
(D) comparing the temperature signals with a background temperature signal to calculate temperature differences and thereby detect temperature changes in the region.

2. The method of claim 1, wherein the infrared detection devices are infrared temperature sensors.

3. The method of claim 2, wherein the infrared detection devices are in number of four.

4. The method of claim 1, wherein the first time interval is 62.5 ms.

5. The method of claim 1, wherein the second time interval is 62.5 ms.

6. The method of claim 1, wherein the background temperature signal is generated by calculating a weighted average with the newly-captured temperature signals of the infrared detection devices.

7. The method of claim 1, wherein a temperature difference threshold is configured for use in detecting temperature changes in the region, and it will be justified to determine that a temperature change occurs to the region, if the difference between a temperature indicated by an aforesaid temperature signal and a temperature indicated by the background temperature signal is larger than the temperature difference threshold.

8. The method of claim 1, wherein the region is divided into a plurality of sub-regions whose temperature changes are detected.

9. The method of claim 1, wherein the sub-regions are arranged in a 4×4 matrix and thus provided in number of 16.

10. The method of claim 1, further comprising the step of:
(E) converting a result of the comparison between the temperature signals of the plurality of infrared detection devices and the background temperature signal into a voltage signal, allowing a first volt value to denote presence of a temperature difference and a second volt value to denote absence of a temperature difference, and performing computation on all the comparison results with a logic integration circuit by an OR logical operator, so as for a result of the computation to indicate whether the region undergoes a temperature change.

11. The method of claim 10, wherein the first volt value is 5V, and the second volt value is 0V.

12. A method of detecting moving vehicles with infrared, comprising the steps of:
(A) detecting temperature changes in a plurality of sub-regions at the first point in time with the method of claim 8;
(B) dividing the plurality of sub-regions into a plurality of rows according to a predetermined vehicle advancing direction;
(C) detecting temperature changes in the plurality of sub-regions at the second point in time with the method of claim 8; and
(D) comparing the detection results of the first point in time and the second point in time, and determining that the vehicle is moving in one of the plurality of rows upon detection of temperature changes in the row at both the first point in time and the second point in time and upon detection that the sub-regions which undergo temperature changes at the second point in time in the row are different from the sub-regions which undergo temperature changes at the first point in time in the row.

13. The method of claim 12, wherein the sub-regions are arranged in a 4×4 matrix and thus provided in number of 16 in step (A) and step (C), and the sub-regions are arranged in four rows in step (B) and step (D).

14. The method of claim 12, wherein the plurality of sub-regions each allow for a 1 m×1 m detection area.

15. The method of claim 12, wherein the sub-regions are divided into an upper group and a lower group according to a line located at a crossroads and intended for vehicles to stop at, so as to determine whether the moving vehicle has gone beyond the stopping line at the crossroads according to whether the sub-regions which undergo the detected temperature changes belong to the upper group or the lower group.
